(19) United States
(12) Patent Application Publication
(10) Pub. No.: US 2026/0111635 A1
(43) Pub. Date: Apr. 23, 2026

(54) MULTIPHASE FLUID FRAMEWORK

(71) Applicant: Schlumberger Technology Corporation, Sugar Land, TX (US)

(72) Inventors: Kyle Macfarlan, Houston, TX (US); Steven Fulk, Houston, TX (US)

(21) Appl. No.: 18/923,141

(22) Filed: Oct. 22, 2024

(51) Int. Cl. G06F 30/28; G06F 111/10

(52) U.S. Cl. CPC G06F 30/28; G06F 2111/10

(57) ABSTRACT

A method may include controlling a computational simulator to perform an inner loop that solves mass balance and energy balance of a rate-based separation process using thermodynamic and physical properties to generate an inner loop result; controlling the computational simulator to perform an outer loop using the inner loop result to generate an outer loop result that includes updated thermodynamic and physical properties; and controlling the computational simulator to terminate performance of the inner loop and the outer loop responsive to iterative convergence of the outer loop result.

### BACKGROUND

Equipment may be utilized to perform various operations. During such operations, equipment may experience one or more types of issues that may impact the operations, whether past, present and/or future. As an example, consider equipment that may perform operations with respect to multiphase fluid, which may be involved in a separation process, a reservoir flow process, a fluid network process, etc. In various instances, multiphase fluid may include multiple components. For example, consider a multiphase fluid that includes one or more gas phase (e.g., vapor phase) components and one or more liquid phase components. In such an example, a liquid phase component may be an absorber for absorbing a component from a gas phase. For example, consider a separation process for separating CO2 from a stream fed to a trayed-column using an absorber stream fed to the trayed-column. In various instances, multiphase fluid behavior may involve mass transfer and energy transfer, which may pose challenges to design, operation, and control of equipment for handling multiphase fluid.

### SUMMARY

A method may include controlling a computational simulator to perform an inner loop that solves mass balance and energy balance of a rate-based separation process using thermodynamic and physical properties to generate an inner loop result; controlling the computational simulator to perform an outer loop using the inner loop result to generate an outer loop result that includes updated thermodynamic and physical properties; and controlling the computational simulator to terminate performance of the inner loop and the outer loop responsive to iterative convergence of the outer loop result. A system may include a processor; a memory accessible to the processor; processor-executable instructions stored in the memory and executable by the processor to instruct the system to: control a computational simulator to perform an inner loop that solves mass balance and energy balance of a rate-based separation process using thermodynamic and physical properties to generate an inner loop result; control the computational simulator to perform an outer loop using the inner loop result to generate an outer loop result that includes updated thermodynamic and physical properties; and control the computational simulator to terminate performance of the inner loop and the outer loop responsive to iterative convergence of the outer loop result. One or more computer-readable media may include computer-executable instructions executable by a system to instruct the system to: control a computational simulator to perform an inner loop that solves mass balance and energy balance of a rate-based separation process using thermodynamic and physical properties to generate an inner loop result; control the computational simulator to perform an outer loop using the inner loop result to generate an outer loop result that includes updated thermodynamic and physical properties; and control the computational simulator to terminate performance of the inner loop and the outer loop responsive to iterative convergence of the outer loop result. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations may be more readily understood by reference to the following description taken in conjunction with the accompanying drawings.

FIG. 1 illustrates an example system that includes various framework components associated with one or more geologic environments;

FIG. 2 illustrates examples of systems;

FIG. 3 illustrates an example of a workflow;

FIG. 4 illustrates an example of a system;

FIG. 5 illustrates an example of a schematic of phenomena;

FIG. 6 illustrates an example of a schematic of a separation process;

FIG. 7 illustrates an example of a schematic of a separation process;

FIG. 8 illustrates an example of a method;

FIG. 9 illustrates an example of a method;

FIG. 10 illustrates an example of a system;

FIG. 11 illustrates an example of a method and an example of a system; and

FIG. 12 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

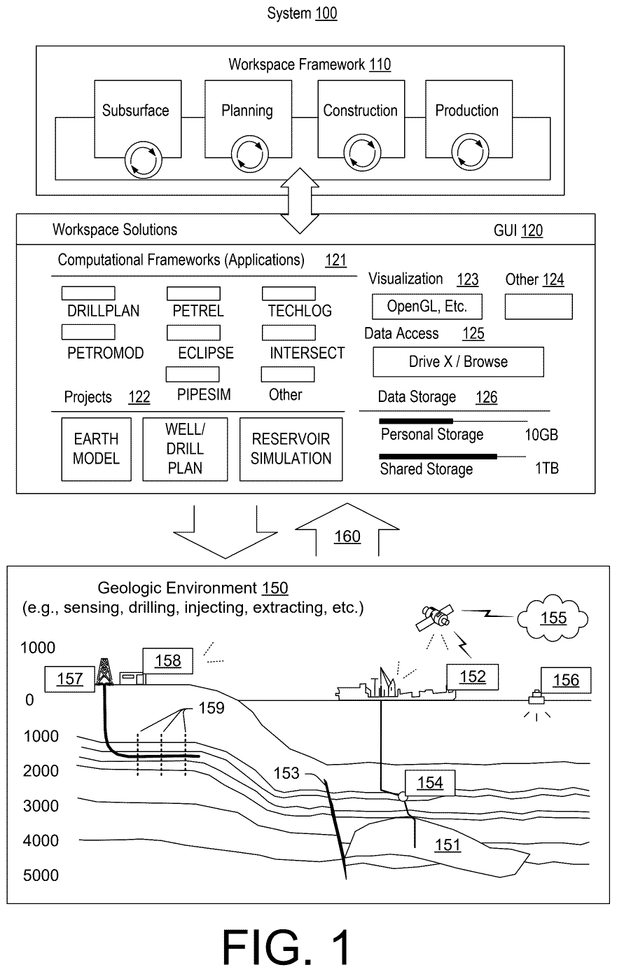

FIG. 1 shows an example of a system 100 that includes a workspace framework 110 that may provide for instantiation of, rendering of, interactions with, etc., a graphical user interface (GUI) 120. In the example of FIG. 1, the GUI 120 may include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As an example, the system 100 of FIG. 1 may provide for performing one or more field operations related to one or more greenhouse gases (GHGs), such as, for example, one or more of CO2, CH4, etc. As an example, a field operation may involve injecting fluid into a reservoir via one or more wells, for example, to sequester or otherwise store one or more GHGs.

In the example of FIG. 1, the GUI 120 shows some examples of computational frameworks, including the DRILLPLAN, PETREL, TECHLOG, PETROMOD, ECLIPSE, PIPESIM, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework may be part of the DELFI cognitive E&P environment (SLB, Houston, Texas) for utilization in geosciences and geoengineering, for example, to analyze subsurface data from exploration to production of fluid from a reservoir.

The TECHLOG framework may handle and process field and laboratory data for a variety of geologic environments (e.g., deepwater exploration, shale, etc.). The TECHLOG framework may structure wellbore data for analyses, planning, etc.

The PETROMOD framework provides petroleum systems modeling capabilities that may combine one or more of seismic, well, and geological information to model the evolution of a sedimentary basin. The PETROMOD framework may predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework may produce reliable results, which may be continuously updated by real-time data exchanges (e.g., from one or more types of data acquisition equipment in the field that may acquire data during one or more types of field operations, etc.). The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 may be utilized for directing, controlling, etc., one or more processes in the geologic environment 150 and, feedback 160, may be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages. Examples of such software packages include the PETREL framework. As an example, a system or systems may utilize a framework such as the DELFI framework (SLB, Houston, Texas). Such a framework may operatively couple various other frameworks to provide for a multi-framework workspace. As an example, the GUI 120 of FIG. 1 may be a GUI of the DELFI framework.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results may be utilized to plan, simulate, perform, etc., one or more operations for production of fluid from a reservoir (e.g., reservoir rock, etc.).

As an example, a model may be a simulated version of a geologic environment. As an example, a simulator may include features for simulating physical phenomena in a geologic environment based at least in part on a model or models. A simulator, such as a reservoir simulator, may simulate fluid flow in a geologic environment based at least in part on a model that may be generated via a framework that receives seismic data. A simulator may be a computerized system (e.g., a computing system) that may execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that may be based on interpretation of seismic and/or other data.

While several simulators are illustrated in the example of FIG. 1, one or more other simulators may be utilized, additionally or alternatively. For example, consider the PIPESIM network simulator (SLB, Houston Texas), etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that may optimize one or more operational scenarios at least in part via simulation of physical phenomena.

As an example, the SYMMETRY framework (SLB, Houston, Texas) may be utilized, which includes process simulation features that may model process workflows, integrating facilities, process units with pipelines, networks and flare, safety systems models, while ensuring thermodynamic and fluid characterization across a system. Such a framework may be operatively coupled with one or more other frameworks. As an example, a workflow may aim to optimize processes in upstream, midstream and/or downstream sectors, which, may, for example, aim to maximize efficiency and minimize CAPEX.

As an example, the SYMMETRY framework may provide for process simulation to model process workflows in an environment, for example, via one or more of integrating facilities, process units with pipelines, networks and flare, safety systems models, while ensuring consistent thermodynamics and fluid characterization across a system. Such an approach may provide for optimizing one or more processes in upstream, midstream, and/or downstream sectors.

As mentioned, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment may provide for operations that involve one or more frameworks. The DELFI environment may be referred to as the DELFI framework, which may be a framework of frameworks. As an example, the DELFI framework may include various other frameworks, which may include, for example, one or more types of models (e.g., simulation models, etc.).

As an example, a workflow may utilize one or more types of data for one or more processes (e.g., stratigraphic modeling, basin modeling, completion designs, drilling, production, injection, etc.). As an example, one or more tools may provide data that may be used in a workflow or workflows that may implement one or more frameworks.

As mentioned, a process may involve storage of one or more GHGs. As an example, a reservoir simulator such as that of the ECLIPSE framework, the INTERSECT framework, etc., may provide for simulating one or more GHG-related processes. The ECLISPE framework includes various dynamic simulation options for CO2 storage. For example, consider the CO2STORE option, designed for modeling geological storage of CO2 in saline aquifers where three phases may be considered: a CO2-rich gas phase, an H2O-rich aqueous phase, and a solid phase. As an example, mutual solubilities of CO2 and H2O may be utilized, as may be based on fugacity equilibration. As an example, brine density may be adjusted for dissolved salt and CO2. As an example, effects of halite and calcite precipitation and dissolution may be modeled using chemical reactions. As an example, CO2STORE may be used with temperature- and pressure-dependent component K-values for phase equilibrium calculations. As an example, an oil phase may be defined in addition to a CO2-rich phase and an H2O-rich phase, and thermal properties of rock may be included in a model.

As an example, the GASWAT option may be utilized, for example, for CO2 injection in depleted gas reservoirs, for EGR and/or storage. In such an example, a two-phase model that represents gas phase and aqueous phase equilibria may be utilized, for example, via a modified Peng-Robinson equation of state. In such an example, gas composition may include CO2, N2, H2S, H2O and hydrocarbon gases. As an example, aqueous phase coefficients, binary interaction components and salinity may be adjusted to match observed lab and/or field data

As an example, the CO2SOL option may be utilized for three-phase compositional modeling of CO2 injection in depleted oil reservoirs, for EOR and/or storage. As an example, CO2 may be present in one or more of oil, gas, and water phases. As an example, CO2 solubility in water may be computed using a fugacity function and depends on pressure, salinity, temperature, and composition.

As to the INTERSECT framework, it may provide for simulation of complex compositional cases as a tool for CO2 EOR projects. As an example, one or more features for modeling chemical reactions may be implemented, which may assist with assessing CO2 storage functionality.

As an example, extensibility features of the INTERSECT framework may be implemented to tailor computations using PYTHON scripts and/or interface with one or more other packages for geochemistry, geomechanics, etc. As an example, run-time efficiency of the INTERSECT framework simulator may provide for representation of effects of heterogeneities on CO2 migration, as well as fast turn-around for multiple realizations in uncertainty studies.

In various instances, uncertainty may present challenges in CO2 storage. Subsurface characterization data may be relatively limited for deep saline aquifers yet quantification of risks may be desirable for storage projects, for example, to design monitoring programs, control schemes, optimization of costs/benefits, satisfaction of regulations, etc.

As an example, the PETREL framework may provide for implementation of workflows for constructing probability maps, which may inform planning of seismic surveys for a CO2 injection project (e.g., consider 3D surveys, 4D surveys, etc.). As an example, multiple simulations may be executed using on-demand reservoir simulation features implemented using one or more cloud platforms, which may include enhanced support for workflows in the DELFI cognitive E&P environment.

As explained, one or more frameworks may provide for understanding complex physical and chemical behavior of CO2, which may be a component of a hydrocarbon phase and/or an aqueous phase. Above the critical point (temperature 31 degC, pressure 73.8 bar) pure CO2 exists as a supercritical dense phase, with gas-like viscosity and liquid-like density. Below the critical point it may exist as gas or liquid. Injected CO2 may become miscible with oil at high pressures. CO2 solubility in the aqueous phase depends on the reservoir conditions and brine composition: solubility increases with decreasing temperature and/or with increasing pressure and decreases with increasing brine salinity. Characteristics of CO2 and/or one or more other GHGs may be modeled, simulated, etc., at one or more points along an overall carbon capture, utilization, and storage (CCUS) workflow.

As an example, a computing environment, framework, etc., may include features for interactivity, control, operative coupling, etc. For example, consider the IAM framework (SLB, Houston, Texas), which enables coupling of a wide number of simulation applications, such as, for example, one or more of reservoir simulation models (e.g., ECLIPSE, etc.); compositional, thermal, and streamline reservoir simulation (e.g., INTERSECT, etc.); material balance tank model for reservoir modeling; multiphase flow simulation models (e.g., PIPESIM, OLGA, etc.); process and facilities simulation models (e.g., SYMMETRY, etc.); etc. As an example, a computing environment, framework, etc., may provide for interfaces, adapters, etc. (e.g., REST application programming interfaces (APIs), OPC DA model adapters, etc.). As an example, one or more technologies, features, etc., may be implemented as to component interactivity. For example, JSON (JavaScript Object Notation) may be utilized as a format for sending and requesting data through a REST API where, for example, a response to an API call may be formatted as JSON.

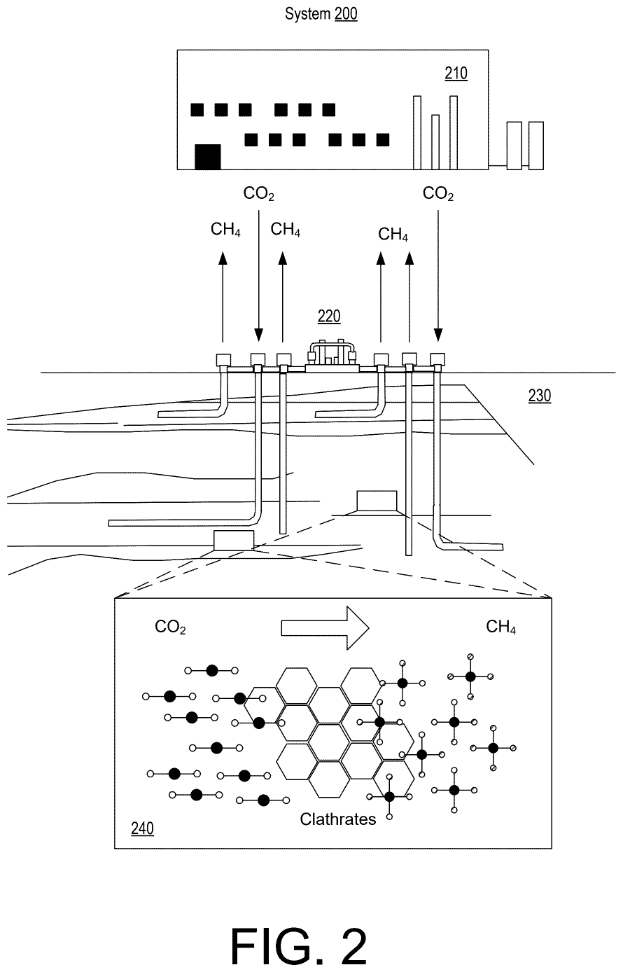

FIG. 2 shows an example of a system 200 that includes a facility 210 that may produce CO2 and consume methane (CH4), equipment 220 with conduits extending into a subsurface region 230 and various processes 240 where, for example, CO2 may be sequestered as methane is released. In particular, the subsurface region 230 may include clathrates and/or clathrate forming materials that may provide spaces to hold CO2 and/or CH4. In the example of FIG. 2, the system 200 may include and/or be operatively coupled to a geologic chemical transport framework that may provide for generating results (e.g., simulation results, etc.) for such field operations where the results may include results for geochemistry. As explained, CO2 may react with H2O, which may, in turn, interact with rock, for example, to change the rock physically and/or chemically. As an example, one or more field operations may be controlled using results generated by the geologic chemical transport framework. For example, consider control of one or more parameters related to CO2 injection (e.g., pressure, temperature, flow rate, location, treatment, etc.).

Clathrate hydrates represent a class of solid-state materials. Clathrate hydrates exist in oceans and permafrost regions and exhibit an ability to trap atoms and small molecules (e.g., methane and other small hydrocarbons). Where hydrocarbons are trapped, clathrate hydrates may serve as an energy source. In the oil and gas industry, solid methane clathrate hydrate may plug natural gas pipelines and disrupt oil drilling processes.

As an example, clathrate hydrates may be utilized to store hydrogen and/or sequester CO2. Trapping of CO2 molecules in clathrate hydrates may be a controllable process that may provide a way to reduce CO2 levels in gas. As an example, clathrate hydrates may be utilized in separation of gases such as CO2 from gas (e.g., flue gases, desalination, etc.). For example, clathrate hydrates may be used in flue gases to separate CO2 by encouraging the formation of CO2 clathrate hydrate in a flue gas mixture. As to hydrate-based desalination, a process may commence when clathrate hydrate forming agent is injected into seawater that has a surrounding temperature lower than clathrate hydrate forming temperature where such a condition promotes solidification and condensation of water molecules around the hydrate formers such that a slurry of clathrate ice and brine form. Once formed, brine may be separated from the slurry of clathrate ice and the clathrate melted via heat exchange with warmer surface water of the ocean.

As an example, a geologic chemical transport framework may provide for modeling and generation of results of one or more processes that may involve injection of CO2 where geochemical reactions may occur that may impact one or more physical properties of rock of a subsurface region.

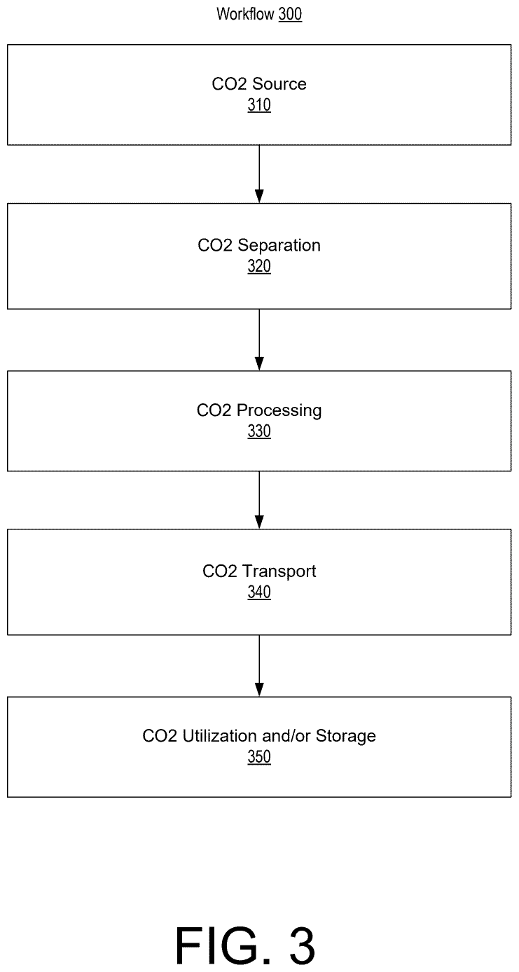

FIG. 3 shows an example of a workflow 300 as to handling of CO2, which includes a CO2 source block 310 for sourcing CO2, a CO2 separation block 320 for separating CO2 from a CO2 source, a CO2 processing block 330 for processing separated CO2, a CO2 transport block 340 for transporting CO2, and a storage and/or utilization block 350 for storing and/or utilizing transported CO2. For example, the block 350 may involve injecting CO2 into a subsurface environment for purposes of storage, for example, as indicated in the example of FIG. 2.

As an example, one or more frameworks may be implemented to improve a workflow such as the workflow 300 of FIG. 3 via process simulation and/or optimization. Challenges may arise due to one or more factors, which may include capital cost (e.g., as to separation equipment to handle throughput, multi-stage intercooled compressors, etc.) and/or operating costs (e.g., as to regeneration energy, blower, compression and/or pump work, etc.). In various instances, separation processes may be a primary factor in efficacy, feasibility, etc. (see, e.g., the CO2 separation block 320).

As an example, a framework may provide for improved separation processes. In such an example, the framework may provide for handling one or more of separation tower size, gas rates (e.g., capacity), contact efficiency versus pressure drop, chemical kinetics, regeneration energy, heat of absorption, heat capacity, solubility, cyclic capacity, etc. For example, a framework may implement a model or models that may handle details as to such factors.

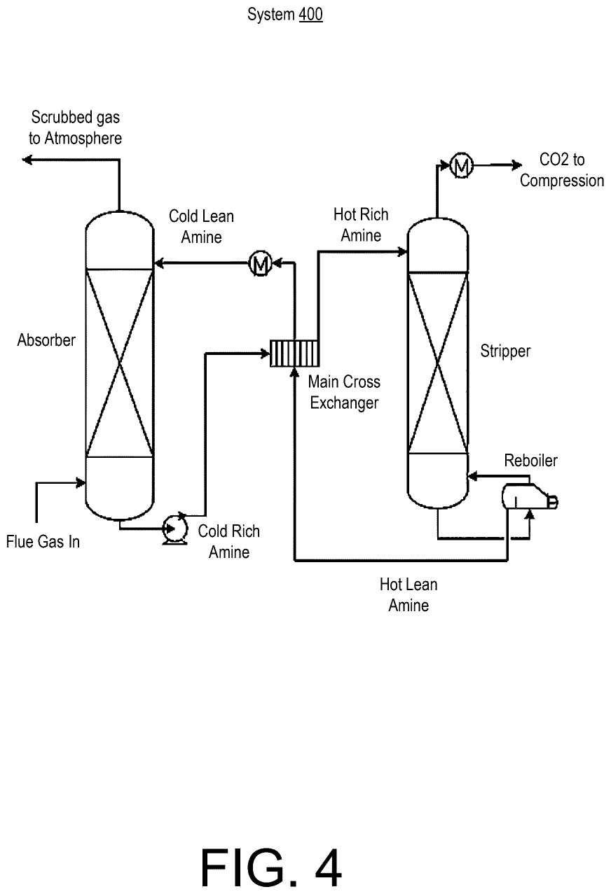

FIG. 4 shows an example of a system 400 that includes an absorber and a stripper where an amine is utilized to absorb CO2 from flue gas in the absorber where CO2 is stripped from the amine in the stripper. The system 400 may aim to achieve equilibrium, however, various types of phenomena may pose challenges as to reaching equilibrium in a time and/or cost-effective manner.

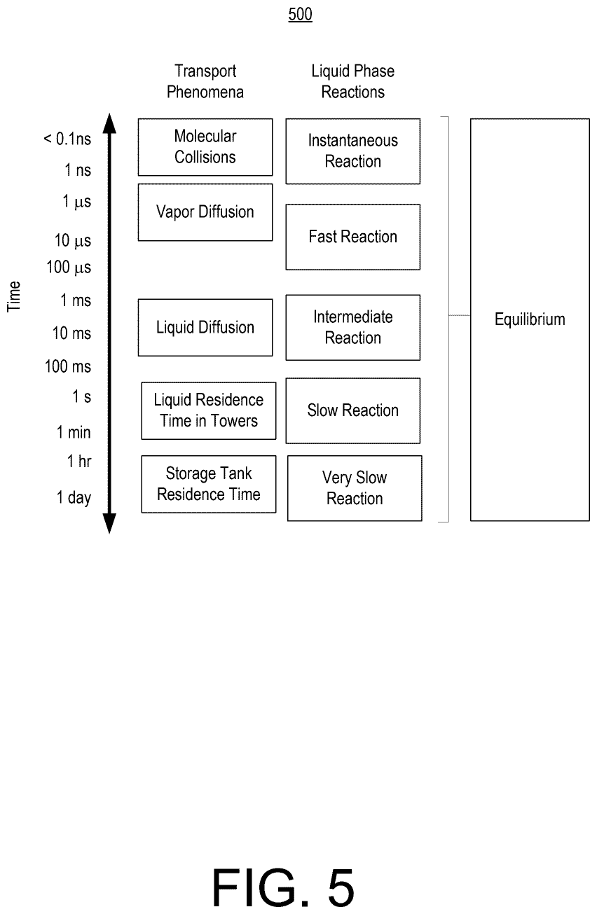

FIG. 5 shows an example of a diagram 500 of various phenomena along with approximate time scales that may govern dynamics of separation using a system such as the system 400. As shown in the diagram 500, local transport phenomena and liquid phase reaction phenomena may dictate dynamics as to equilibrium. As an example, a framework may provide for improved determinations as to such dynamics, which may provide for estimating extent and/or time of equilibrium.

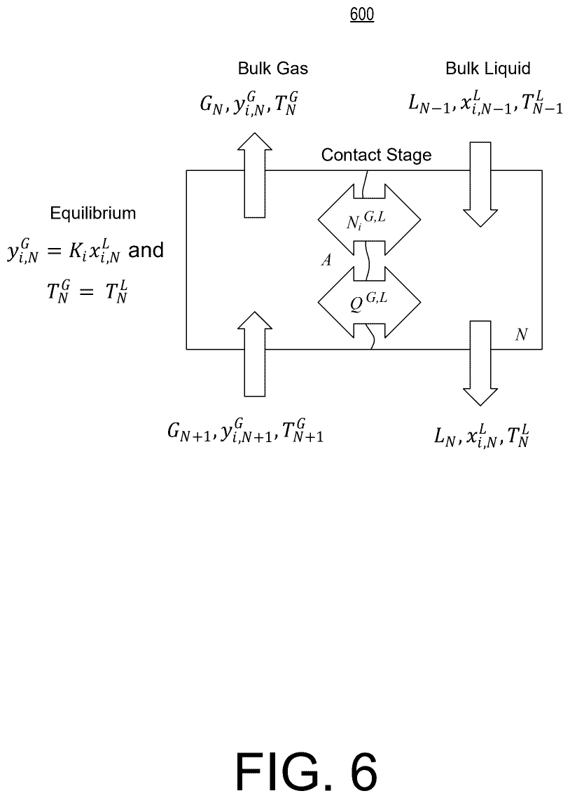

FIG. 6 shows an example of an equilibrium diagram 600 that includes bulk gas, bulk liquid, and a contact stage, as may be associated with a discrete tray (e.g., stage) of a multi-stage (e.g., multi-tray) column. In such an example, an equilibrium stage may be defined using 2N_{c}+3 equations, where N_{c} is the number of components. As an example, an approach that consider material equilibrium summation enthalpy (MESH) may be utilized, which involves a concept in thermodynamics where, at a state of material equilibrium, the total enthalpy of a system may be computed by summing up the enthalpy contributions of each individual component within the system, taking into account their respective amounts and phases (e.g., total heat content of a system at equilibrium, considering all the substances present).

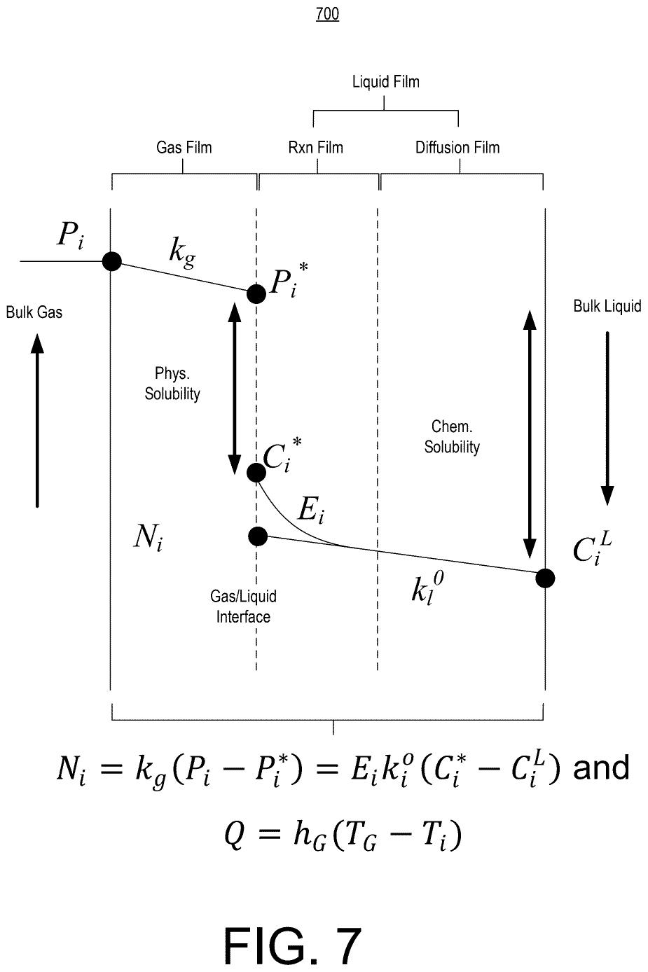

FIG. 7 shows an example of a diagram 700 for a rate-based approach, which may provide for a rate-based stage defined by 5N_{c}+6 equations. As an example, a material, energy, rate (e.g., mass and heat), summation, hydraulic, and interface equilibrium approach may be referred to as an MERSHQ approach. As shown, such an approach may consider particular aspects of contact stage dynamics.

As an example, a rate-based approach may consider mass transfer with reaction involving gas diffusion as a driving force, gas solubility in liquid (e.g., equilibrium), chemical reaction (e.g., liquid phase), and liquid diffusion as a driving force; mass transfer rates that depend on area for mass transfer, vapor and liquid loads, T, P, Z, and physical and transport properties (e.g., μ, σ, ρ, D, etc.), and driving force for phases that are not in equilibrium; and heat transfer rates that depend on area for heat transfer, vapor and liquid loads, T, P, Z, and physical and transport properties (e.g., cₚ, μ, σ, ρ, κ, etc.), and driving force of phases that are not in equilibrium.

As to a rate-based approach, it may demand data relating to equilibrium (e.g., physical properties, transport properties, reaction kinetics, contactor geometry, etc.) and may demand accurate models (e.g., properties and transfer coefficients intimately tied, with risks of error propagation due to number of computations). As explained, given the increased number of equations, a rate-based approach demands more computation power and memory (e.g., 5N_{c}+6 equations versus 2N_{c}+3 equations). A rate-based approach may present challenges given a resulting large, non-linear problem, which may exhibit issues as to convergence, stability, etc.

As an example, a framework may provide for rate-based column simulation to generate results as to equilibrium of a system and how fast the system may be moving to equilibrium. In various instances, process times may be less than a transport mechanism timescale (e.g., demanding a rate-based computation). As an example, while CO2 absorbing and stripping are mentioned (e.g., CCS amine treating (kinetics)), one or more other processes may benefit from rate-based tower modeling. As explained, a framework may provide for handling a relatively large, non-linear problem.

Referring to FIG. 6, the following equations are presented for bulk gas as to stages N and N+1, where N is utilized as a subscript and where the index i represents components (e.g., from 1 to N_{c}):

$${G}_{N} , {y}_{i , N}^{G} , {T}_{N}^{G} and$$

$${G}_{N + 1} , {y}_{i , N + 1}^{G} , {T}_{N + 1}^{G}$$

Referring to FIG. 6, the following equations are presented for bulk liquid as to stages N and N−1, where the index i represents components (e.g., from 1 to N_{c}):

$${L}_{N} , {x}_{i , N}^{L} , {T}_{N}^{L} and$$

$${L}_{N - 1} , {x}_{i , N - 1}^{L} , {T}_{N - 1}^{L}$$

Referring to FIG. 6, the following equations are presented for equilibrium as to stage N, where the index i represents components (e.g., from 1 to N_{c}):

$${y}_{i , N}^{G} = {K}_{i} {x}_{i , N}^{L} and$$

$${T}_{N}^{G} = {T}_{N}^{L}$$

Referring to FIG. 6, the following parameters are presented for a contact stage:

$${N}_{i}^{G , L} , A , {Q}^{G , L} .$$

As shown in FIG. 6, given the numbering convention for stages, gas may enter from a higher numbered stage and liquid may enter from a lower numbered stage such that counter current flow exists for gas and liquid.

Referring to FIG. 7, the following equations may be utilized to characterize stage phenomena in counter current flow:

$${N}_{i} = {k}_{g} ( {P}_{i} - {P}_{i}^{*} ) = {E}_{i} {k}_{i}^{o} ( {C}_{i}^{*} - {C}_{i}^{L} ) and$$

$$Q = {h}_{G} ( {T}_{G} - {T}_{i} )$$

In the foregoing equations, Nᵢ is the molar flux of component i where a constant, kg, is the mass transfer coefficient in a gas film exposed to a bulk gas where a physical solubility determines concentration in a reaction film layer of a liquid film that also include a diffusion film where a constant, Et, is the Enhancement Factor which captures concentration non-linearities in the reaction film layer due to chemical reactions and where a constant,

$${k}_{i}^{o} ,$$

is a mass transfer coefficient that controls chemical solubility with respect to a bulk liquid. As to heat energy, a constant, h_{G}, may be utilized as a heat transfer coefficient. As to the term mass transfer rate, it refers to the overall rate at which a substance moves from one phase to another, while the term molar flux may be utilized as the specific measure of that rate expressed as the number of moles of a substance passing through a unit area per unit time.

As an example, the following equations may be utilized for each phase in each stage:

$${N}_{i} = c {K}^{=} \overline{Δ x} + {x}_{i} {N}_{t}$$

$$0 = {\sum }_{feeds} {H}_{i} {F}_{i} - {\sum }_{prods} {H}_{i} {F}_{i} + \sum {H}_{i} {N}_{i}$$

$$0 = {\sum }_{feeds} {F}_{i} - {\sum }_{prods} {F}_{i} + \sum {N}_{i}$$

$${y}_{i}^{*} = {K}_{i} {x}_{i}^{*}$$

In the foregoing form, the equations appear to be relatively linear and straightforward. However, in practice, the equation parameters (K̅, Kᵢ, Hᵢ) are dependent on the independent variables (xᵢ, T, Fᵢ), expensive to compute, and without analytic derivatives.

As an example, an inside-out technique may be utilized, for example, as may find use in flash computations. As an example, a simulator may utilize one or more simplified models for one or more parameters and update such one or more parameters in an outer loop. As an example, such an approach may be implemented for rate-based simulation, for example, for distillation columns, etc.

As an example, an inside-out technique may provide for improving robustness and performance of distillation column simulation, while considering physical heat and mass transfer limitations. As an example, such an approach may provide for rate-based modeling of distillation columns, which may provide for determinations as to separations such as, for example, CO2 separation. As an example, an inside loop may provide for solving numerics of mass and energy balances with simplified thermodynamic and physical properties and an outer loop may provide updates rigorously as to thermodynamic and physical properties.

As an example, to improve robustness an homotopy approach may be utilized to remove composition dependency on an inner loop enthalpy model. In such an approach, a method may assume a starting point for a solution that initially has little to no liquid mass transfer.

As an example, a simulator may be implemented within a framework. For example, consider the SYMMETRY framework, which may provide for rate-based model simulations.

As an example, an inside-out technique may be utilized for solving an overall system of equations for rate-based dynamics. In such an example, a method may include determining an effective thermodynamic matrix. As an example, a method may include use of and a specific form of an homotopy technique for solving an inner-loop of a rate-based model.

As an example, a framework may provide a robust and fast inside-out technique that may be applied to model distillation columns as may be limited by physical constraints. In such an example, the technique may provide for decoupling numerical solving from estimation of thermodynamic and physical properties. As an example, a numerical layer may be informed by a thermodynamic and physical layer.

As explained, a rate-based simulator may provide for improved modeling, control, etc., of one or more processes associated with CCUS. As an example, such a simulator may provide for improved speed and robustness, which may, in turn, provide for increased efficiency (e.g., for control, simulation, optimization, etc.).

As an example, a framework may provide for implementation of an inner loop, solved using Newton's method, for example, to solve mass and energy balances, along with equilibrium relationships using simplified thermodynamic and physical properties; and provide for implementation of an outer loop where the thermodynamic and physical properties are updated rigorously. In such an example, convergence may be declared when the results from outer-loop to outer-loop comport with one or more convergence criteria (e.g., change less than some change delta, etc.).

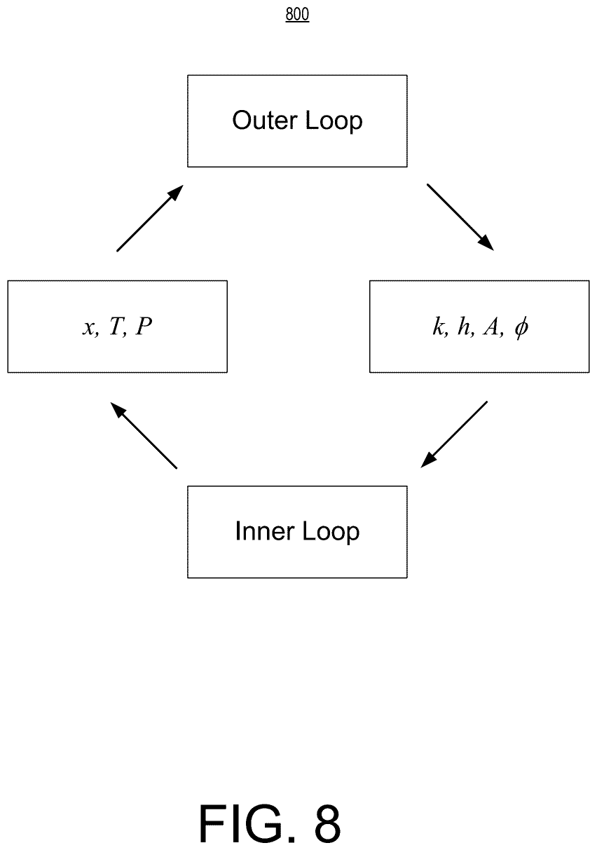

FIG. 8 shows an example method 800 for implementing an inside-out technique. As shown, an outer loop may provide for successive substitution (e.g., with damping and/or acceleration) and an inner loop may approximate a model to be solved using Newton's method. In such an example, the outer loop may parameterize inner loop simplifications where, for example, mass and heat transfer coefficients may be held constant and computed in the outer loop along with a simplified enthalpy and fugacity model generated in the outer loop. As an example, an inside-out approach may provide for improved quality assurances as to quality of one or more inner loop models.

As mentioned, a framework such as the SYMMETRY framework may be improved via implementation of an inside-out technique. The SYMMETRY framework may utilize a rate-based approach that implements a Newton's method-based solver that may include features of the Deuflhard's NLEQ-ERR technique (see, e.g., Deuflhard, P., “Newton Methods for Nonlinear Problems: Affine Invariance and Adaptive Algorithms”, Springer-Verlag, Berlin, 2004, xii+424 pp., ISBN 3-540-21099-7, which is incorporated by reference herein).

As an example, homotopy (e.g., path continuation) may be utilized as a technique layered on top of Newton's method to solve particularly challenging problems. For example, consider a technique that aims to solve an “easy” problem and then continues from a solution to the “easy” problem to find a solution to a “harder” problem. As an example, consider the following equation that may represent such an approach where G is the easier problem and F is the harder problem:

$$0 = λ F ( x ) + ( 1 - λ ) G ( x )$$

In such an example, a technique may aim to develop a good homotopy function G(x), which may be domain-informed. For example, an improved G(x) may be grounded in physics where λ adds some amount of rigor.

As an example, while one approach for a rate-based process may be to use an equilibrium solution to a problem, such a problem may prove to be already too challenging. As another example, consider a case of zero mass and heat transfer, which may be a much easier problem to solve. One challenge though may arise, as the interface conditions may be undefined if the mass transfer coefficient (MTC) and the heat transfer coefficient (HTC) are zero. However, to address such a challenge, an approach may, for example, aim to tie the interface to one phase (e.g., relatively large MTC/HTC) and make the other phase's MTC/HTC small (e.g., negligibly small or zero).

Another aspect of Newton's method is matrix size, which may demand matrix factorization. As explained, a Newton's method approach demands solving a linear system of equations where, in various instances, due to size, direct (e.g., explicit) sparse matrix methods are appropriate.

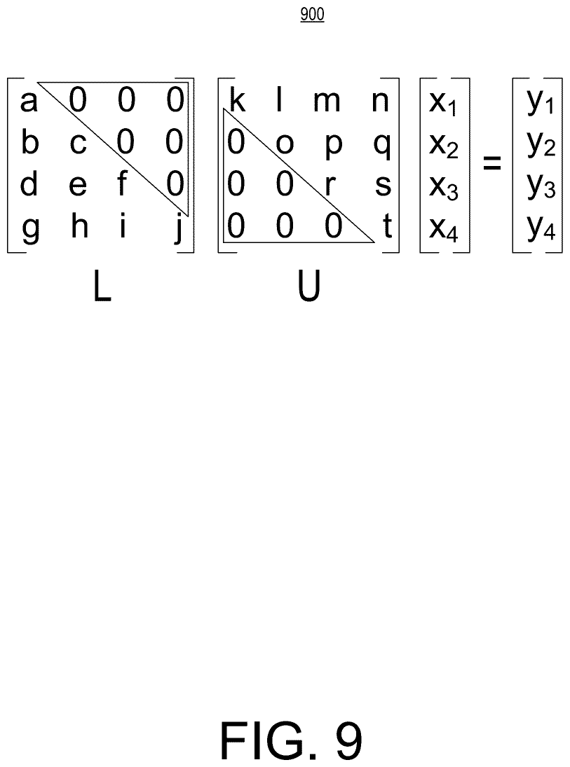

FIG. 9 shows an example of a technique 900, which may be referred to as LU factorization (e.g., LU decomposition), that may be applied to a large, sparse matrix. As an example, one or more factorization techniques may be provided via one or more libraries.

As explained, an inside-out approach may be utilized for rate-based simulation of a process such as a distillation column process. As explained, such a process may be part of a GHG process such as, for example, separation of CO₂. As explained, thermodynamics may be quite relevant to a process where, for example, a thermodynamics matrix may be utilized.

As an example, phenomena may be characterized using a thermodynamic matrix. For example, consider a method of Taylor and Krishna that relies on a thermodynamic matrix Γ̅ to compute the chemical potential gradient from the composition gradient. Such an approach may pose challenges, such as, for example, difficulty and computational expensive to compute the thermodynamic matrix (e.g., constructing this matrix may take approximately 30 percent of an overall solution time).

As an example, to improve simulator operation, a method may aim to effectively “undo” the usual Taylor series expansion to recover an alternative expression for diffusive flux, J̅.

As an example, consider the following equations:

$$\overline{J} = c {K}^{=} \overline{Δ x}$$

$$\overline{J} = c {{R}^{=}}^{- 1} {Γ}^{=} \overline{Δ x}$$

$${Γ}^{=} \overline{Δ x} = ( {I}^{=} + {x}_{i} / \partial x ) \overline{Δ x}$$

$${Γ}^{=} \overline{Δ x} = \overline{Δ x} + \overline{x} ⊙ \overline{Δ ln ϕ}$$

Above, φ (or φ) is the fugacity coefficient (e.g., ratio of fugacity to pressure that may characterize how much a real gas may deviate from ideal gas behavior for given condition(s)) and the symbol ⊙ represents the element-wise multiplication of the matrix elements, also known as the Hadamard product, where each matrix entry is multiplied by its corresponding entry in the other matrix to produce a new matrix. In the foregoing formulation, the diffusive flux may be computed without explicitly computing the thermodynamic matrix. For example, consider the following equation for the diffusive flux:

$$\overline{J} = c {{R}^{=}}^{- 1} ( \overline{Δ x} + \overline{x} ⊙ \overline{Δ ln ϕ} )$$

Such an approach demands computing fugacities at the interface and the bulk, which may depend on composition. However, such an approach has proven to be well-suited for an inside-out style approach where fugacities are updated in an outer loop. As an example, an approach may already demand fugacities at the interface for an equilibrium relationship. As such, demand of fugacities is not overly burdensome.

In various instances, an approach may cause negative mole fractions, and that the choice of a key component may affect a solution substantially. Such behaviors may be likely due to, unlike a gamma matrix formulation, the driving force does not always reduce to zero (e.g., or other low value) if a delta composition goes to zero, due to the addition term. Hence, as an example, a method may employ a technique to use the functional form of the gamma matrix without having to compute it explicitly. For example, consider the following equations:

$${Γ}^{=} \overline{Δ x} = \overline{Δ x} + \overline{x} ⊙ \overline{Δ ln ϕ}$$

$${Γ}^{=} \overline{Δ x} = \overline{Δχ}$$

In such an example, as both vectors may be known, the problem is then to determine a matrix that satisfies this expression. Such a technique may be somewhat akin to Broyden's method for solving systems of equations where, for example, the Jacobian matrix is updated in a relatively convenient manner. In such an approach, there may be a demand that the Jacobian is known (e.g., or estimated) at one point, such that updates may be applied to it. As an example, a technique may provide for use of an assumption that the thermodynamic matrix is equal to the identity matrix as a starting condition, which may be an assumption that represents an ideal case that may be updated as appropriate. For example, consider the following equations:

$${Γ}^{=} \approx {I}^{=}$$

$${{Γ}^{=}}_{n} = {{Γ}^{=}}_{n - 1} + \frac{\overline{Δχ} - {{Γ}^{=}}_{n - 1} \overline{Δ x}}{{‖ \overline{Δ x} ‖}^{2}} {\overline{Δ x}}^{T}$$

Such a technique may provide for convenient and rapid computation of an effective thermodynamic matrix without a demand for generating time-consuming and tedious thermodynamic derivatives.

As explained, a framework may improve simulator robustness through implementation of homotopy to solve a system of equations. In such an approach, a physically-informed homotopy may be implemented rather than a purely mathematical approach. By doing so, the ability for a simulator to generate results becomes more likely, for example, to do so with fewer iterations, which may conserve time and computational resources and, for example, reduce digital error (e.g., digital round-off error, etc.). As explained, a physically-informed homotopy may provide for more realistic intermediate and final results.

As an example, a homotopy approach may consider the type of system to be solved and utilize knowledge of the type of system at the start of a homotopy path (e.g., when λ=0). As explained, a homotopy approach may aim to formulate portions of less difficulty and of more difficulty where, for example, a portion of less difficulty may be at least in part grounded in reality. As explained, one approach may be to try to solve the equilibrium solution as a less difficult portion; however, this may be a challenging problem in itself. As another example, an approach may consider a scenario where there is no mass transfer between the phases, which may seem like an easier problem to solve, as the interphase behavior may be avoided and large swings due to heats of vaporization may be bypassed. For example, consider an approach that involves scaling a mass-transfer k-values by A. While such an approach may reduce difficulty, it does lead to a singularity at the start as the interface conditions are then undefined. As an example, to address this singularity condition, consider a modified approach that involves making one phase (e.g., the liquid phase) have no mass transfer, and the other phase (e.g., the vapor phase) have a relatively large mass transfer. Such a modification may mean that the vapor interface composition will be driven to match a vapor bulk composition, and the liquid interface composition is then defined through the equilibrium relationship with the vapor interface composition. Such an approach may be further simplified by making the vapor ideal (e.g., fugaacity coefficient φ=1) when λ=0. As an example, an inside-out approach may provide for removing composition dependence on an inner loop enthalpy model.

As an example, a framework may provide for implementation of a formulation as follows:

$${N}_{i}^{V} = {\sum }_{k} \frac{1 + ϵ}{λ + ϵ} {k}_{i , k}^{V} ( {y}_{k}^{V} - {y}_{k}^{I} ) + {y}_{i}^{V} {N}_{t}^{V}$$

$${N}_{i}^{L} = {\sum }_{k} λ {k}_{i , k}^{L} ( {x}_{k}^{L} - {x}_{k}^{I} ) - {x}_{i}^{L} {N}_{t}^{V}$$

$${ϕ}_{V} = exp ( λ ln {ϕ}_{V} )$$

$$H = {H}_{ref} + {C}_{p} ( T - {T}_{ref} ) + λ {\sum }_{i} \frac{\partial H}{\partial {x}_{i}} ( {x}_{i} - {x}_{i , ref} )$$

Above, in the molar flux equations, NY is the total molar flux, which may be more generically written without the vapor superscript. As an example, the foregoing equation for enthalpy may be compared to an equation for enthalpy that involves a partial derivative of enthalpy, noting that an equation for the natural log of the vapor-liquid equilibrium constant is also presented, which includes a partial derivative with respect to the reciprocal of temperature:

$$H = {H}_{ref} + {C}_{p} ( T - {T}_{ref} ) + {\sum }_{i} \frac{\partial H}{\partial {x}_{i}} ( {x}_{i} - {x}_{i , ref} )$$

$$lnK = lnK + \frac{\partial lnK}{\partial \frac{1}{T}} ( \frac{1}{T} - \frac{1}{{T}_{ref}} )$$

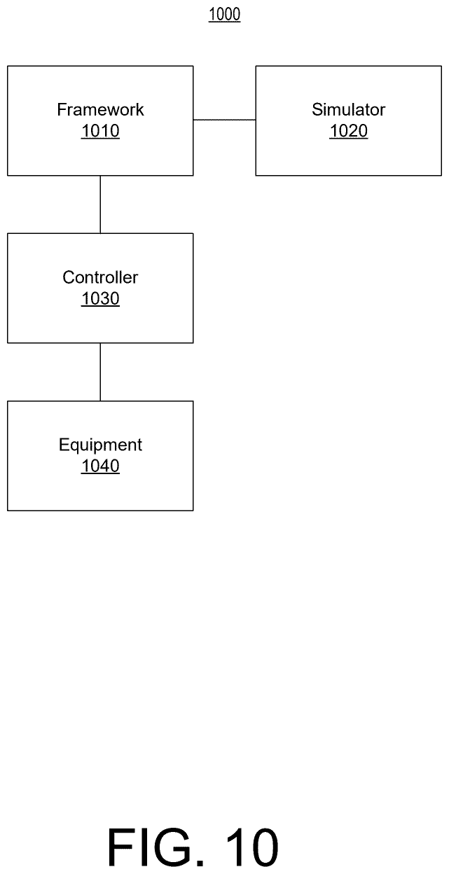

FIG. 10 shows an example of a system 1000 that includes a framework 1010, a simulator 1020, a controller 1030 and equipment 1040. In such an example, the framework 1010 may include and/or be operatively coupled to the simulator 1020. As shown, the framework 1010 may be operatively coupled to the controller 1030 such that the controller 1030 may operate according to output of the framework 1010, which may depend on operation of the simulator 1020. As shown, the controller 1030 may provide for control of the equipment 1040. As an example, the equipment 1040 may include one or more types of equipment for performing operations as may be related to and/or depend upon vapor and liquid (e.g., gas and liquid) and compositions thereof. For example, the equipment 1040 may include one or more separator, one or more pieces of equipment for handling multiphase fluid, etc. As an example, rate-based dynamics may be relevant to separation and/or one or more other processes involving multiphase fluid. As explained, a separation process may provide for contacting streams where one or more components of a stream may be absorbed into another stream. For example, consider contacting a flue gas stream with an amine stream in a separation process for separation of one or more gases from the flue gas stream (e.g., consider CO2 separation).

As an example, a system (e.g., the system 1000, etc.) may utilize one or more interactivity features, components, etc. As mentioned, APIs, adapters, etc., may be utilized, which may be part of a computational environment, framework, etc. As an example, one or more machine learning platforms, libraries, frameworks, etc., may be utilized. For example, consider an artificial intelligence (AI) front-end, back-end, intermediate component, etc., that may provide for handling of input, output, intermediate results, etc. As an example, a system may include an AI component for control, which may provide for assessing convergence, error, stability, instability, etc., as to one or more simulators. In such an example, a method may include controlling a simulator or simulators based on one or more AI assessments. As explained, a system may aim to improve simulation through implementation of one or more techniques to make a result more accurate, take less resources (e.g., time, compute, memory, etc.), etc. As an example, a trained machine learning model may be implemented to assess simulator performance, for example, to help determine when a control decision may be implemented to improve performance, to terminate simulation, etc. As explained, one or more techniques may be selectively implemented to improve simulation, for example, via formulations (e.g., thermodynamic matrix formulation, etc.), use of homotopy, etc. Decisions as to such techniques may depend on simulator performance, which may be assessed via stability, instability, convergence, error, etc. As an example, a decision may depend on how a simulator may be integrated into a system, which may include equipment that may be controlled, for example, to improve a separation process (e.g., CO2 separation, etc.).

As explained, Newton's method may be utilized for solving a system of equations that describe phenomena. Newton's method may depend on an ability to generate values for derivatives. As to convergence, given exact derivatives, Newton's method may provide for quadratic convergence to a solution. For example, Newton's method may progress iteratively where an improved guess may be a root of a linear approximation of a function at an initial guess. An ability to provide improved convergence may provide for generation of more accurate results, which may, for example, be generated in a lesser amount of time (e.g., using lesser overall computational resources). For example, where derivatives are less than exact, for example, via one or more approximation techniques, convergence may take longer, or may not be achieved in various instances. While an approximation technique may provide for lesser computational demands per iteration, if more iterations are required in comparison to a technique that utilizes improved derivatives, then there may be some trade-offs. In various instances, an approach that improves derivatives in view of real-world phenomena may provide a solution in lesser time (e.g., lesser computational resources) than an approach with less accurate derivatives that demand lesser computation per iteration because the improved derivatives in view of real-world phenomena may provide for improved convergence. For example, consider one approach that takes a level of 10 in computational resources per iteration and that takes 10 iterations to converge and another approach that takes a level of 20 in computational resources and that takes 4 iterations to converge. Using these example numbers, the first approach has a total demand of 100 while the second approach has a total demand of 80. Hence, as explained, handling of derivatives matters where derivatives and/or demand thereof may be simplified yet to a level that retains a relationship to actual phenomena relevant to a technical, real-world problem (e.g., separation, etc.).

As an example, a framework may provide for automated switching of a simulator. For example, if a simulator takes more than a certain number of iterations to converge, the framework may switch the simulator to a different solving technique. For example, consider switching to a particular homotopy approach that utilizes a particular approach to formulating a thermodynamic matrix. As explained, such a switch may provide for a reduction in the number of iterations and, for example, may provide for expediting operation of the simulator. Further, such a switch may provide for generation of more accurate results, which may be due to improved convergence, which may be accompanied by lesser digital error (e.g., less digital round-off error, etc.).

As an example, where a controller operates in a real-time or near real-time manner (e.g., responsive within 10 minutes, etc.), a framework may provide for controlling a simulator to provide output relevant to operation of the controller. For example, consider simulation of a separation process where results of such a simulation may provide for implementation of one or more control schemes by the controller. In such an example, consider simulation results that indicate a future value of a parameter, a composition, etc., where the controller may utilize that future value to control equipment (e.g., to improve separation, etc.). As an example, one or more sensors may provide for feedback to a controller where, for example, such feedback may be compared to simulation results. In such an example, if the feedback deviates from the simulation results, a framework may provide for acting thereon, for example, in an effort to check operation of a simulator, which may include controlling operation of the simulator in an effort to improve simulation results, for example, to provide an improved match to sensor-based feedback. In such an example, the framework may instruct the simulator to operate using a particular homotopy approach and/or an approach to a thermodynamic matrix, either or both of which may provide for improved simulation results.

As an example, a framework such as the SYMMETRY framework may provide for implementing one or more simulator operational schemes, which may relate to techniques for solving a system of equations, speed of solving, convergence of solving, etc. As explained, a framework may be operatively coupled to a controller, another framework, etc. As an example, output of a framework may provide for control of a process, which may be a process involving multiple phases, mass transfer, heat transfer, etc. As an example, a framework may provide for operating a simulator in a more robust and reliable manner, for example, with reduced risk of non-convergence and/or increased assurance of accuracy.

As an example, a framework may provide for provisioning computational resources of a simulator, which may be in a mode-dependent manner. For example, consider a framework that may provision local and/or cloud resources for simulator operation. In such an example, the framework may provision in a mode-dependent manner, for example, upon a decision by the framework to switch an operational mode of the simulator. As example, phenomena involving mass transfer and heat transfer may be represented in various manners where, for example, a homotopy approach and an approach for handling a thermodynamic matrix may be implemented, which may be implemented, for example, responsive to sensor-based feedback from an actual process.

As to types of machine learning (ML) models that may be implemented for one or more purposes, consider one or more of a support vector machine (SVM) model, a k-nearest neighbors (KNN) model, an ensemble classifier model, a neural network (NN) model, etc. As an example, a machine learning model may be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). As an example, the TENSORFLOW framework (Google LLC, Mountain View, CA) may be implemented, which is an open-source software library for dataflow programming that includes a symbolic math library, which may be implemented for machine learning applications that may include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California). As an example, one or more features of the KERAS library may be utilized. The KERAS library is an open-source library that provides a PYTHON interface for artificial neural networks (ANNs). The KERAS library may act as an interface for the TENSORFLOW library.

As an example, a training method may include various actions that may operate on a dataset to train a ML model. As an example, a dataset may be split into training data and test data where test data may provide for evaluation. A method may include cross-validation of parameters and best parameters, which may be provided for model training.

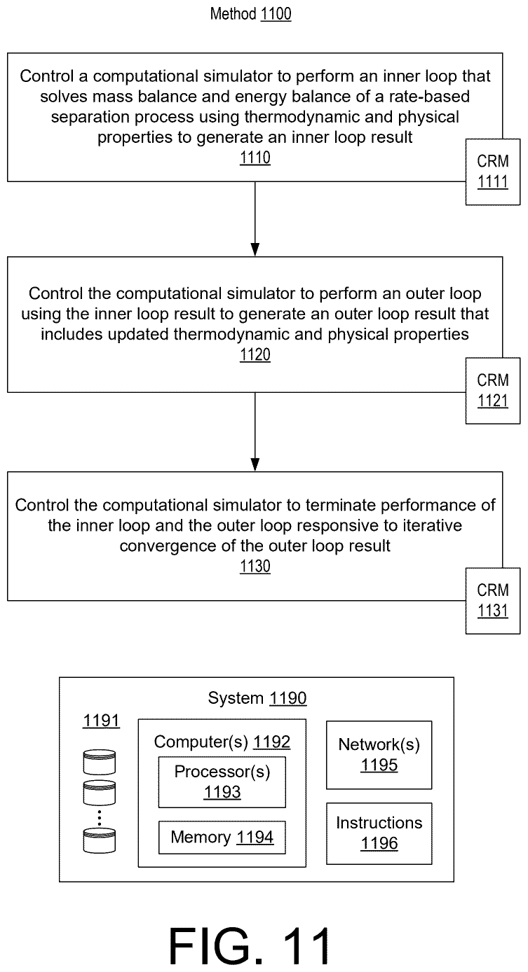

FIG. 11 shows an example of a method 1100 and an example of a system 1190. As shown, the method 1100 may include a control block 1110 for controlling a computational simulator to perform an inner loop that solves mass balance and energy balance of a rate-based separation process using thermodynamic and physical properties to generate an inner loop result; a control block 1120 for controlling the computational simulator to perform an outer loop using the inner loop result to generate an outer loop result that includes updated thermodynamic and physical properties; and a control block 1130 for controlling the computational simulator to terminate performance of the inner loop and the outer loop responsive to iterative convergence of the outer loop result.

In the example of FIG. 11, the system 1190 includes one or more information storage devices 1191, one or more computers 1192, one or more networks 1195 and instructions 1196. As to the one or more computers 1192, each computer may include one or more processors (e.g., or processing cores) 1193 and memory 1194 for storing the instructions 1196, for example, executable by at least one of the one or more processors. As an example, a computer may include one or more network interfaces (e.g., wired or wireless), one or more graphics cards, a display interface (e.g., wired or wireless), etc.

The method 1100 is shown along with various computer-readable media blocks 1111, 1121 and 1131 (e.g., CRM blocks). Such blocks may be utilized to perform one or more actions of the method 1100. For example, consider the system 1190 of FIG. 11 and the instructions 1196, which may include instructions of one or more of the CRM blocks 1111, 1121 and 1131.

As an example, a method may include controlling a computational simulator to perform an inner loop that solves mass balance and energy balance of a rate-based separation process using thermodynamic and physical properties to generate an inner loop result; controlling the computational simulator to perform an outer loop using the inner loop result to generate an outer loop result that includes updated thermodynamic and physical properties; and controlling the computational simulator to terminate performance of the inner loop and the outer loop responsive to iterative convergence of the outer loop result. In such an example, the method may include implementing a homotopy approach for performance of the inner loop and the outer loop. In such an example, the homotopy approach may operate without a compositional dependency on inner loop enthalpy.

As an example, an inner loop may utilize an approximated thermodynamic matrix. In such an example, the approximated thermodynamic matrix may be implemented in the inner loop without generating thermodynamic derivatives.

As an example, a method may include controlling a computational simulator to set an initial condition of negligible liquid mass transfer. In such an example, the method may include operating the computational simulator such that a vapor interface composition is driven to match a vapor bulk composition and such that a liquid interface composition is defined through an equilibrium relationship with the vapor interface composition.

As an example, a rate-based separation process may include separation of CO2 from an inlet gas stream. In such an example, the rate-based separation process may include utilization of an absorber liquid stream to absorb CO2 from the inlet gas stream. For example, consider an amine-based approach where amine or amines are utilized in a liquid stream to absorb CO2.

As an example, a rate-based separation process may include one or more of a tray-based process and a packed-based process. As an example, consider a packed column as a packed-based approach that may include a vertical vessel filled with a packing material; whereas, for example, a tray column as a tray-based approach may include a series of trays with holes or perforations for passage of fluids. As an example, such types of columns may utilize mass transfer mechanisms to transfer a solute from one phase to another and achieve separation of a mixture.

As an example, a method may include utilizing iterative convergence of an outer loop for performing an assessment, for example, using one or more convergence criteria. As explained, one or more techniques may be implemented to assess simulator performance, which may include comparing to real-time data of a process (e.g., a separation process), real-time data of simulator performance, etc. As explained, in various instances one or more AI approaches may be implemented, for example, consider one or more machine learning model-based approaches. As an example, one or more rule-based approaches may be utilized, which may include use of thresholds as to values, thresholds as to time, etc. As explained, a method may provide for improving simulation such that simulation is more efficient and/or more accurate.

As an example, a method may include instructing a controller to control separation equipment based at least in part on an outer loop result. In such an example, the method may include receiving sensor-based data from one or more sensors of the separation equipment and comparing one or more of an inner loop result and the outer loop result to at least a portion of the sensor-based data. In such an example, the method may include controlling a computational simulator responsive to the comparing. In such an example, controlling of the computational simulator may occur responsive to the comparing, for example, by switching one or more computational techniques of one or more of the inner loop and the outer loop. As explained, a method may include controlling separation equipment, which may include controlling pressure, flow rate, temperature, etc. In such an example, one or more valves, heaters, coolers, compressors, etc., may be controlled.

As an example, a method may include controlling a computational simulator to perform a simulation for a rate-based separation process using a different operational mode to iteratively converge to a benchmark result. In such an example, the method may include comparing one or more of an inner loop result and an outer loop result to the benchmark result. In such an example, the method may include, responsive to the comparing, selecting an operational mode from a number of different operational modes and controlling the computational simulator to operate according to the selected operational mode.

As an example, a system may include a processor; a memory accessible to the processor; processor-executable instructions stored in the memory and executable by the processor to instruct the system to: control a computational simulator to perform an inner loop that solves mass balance and energy balance of a rate-based separation process using thermodynamic and physical properties to generate an inner loop result; control the computational simulator to perform an outer loop using the inner loop result to generate an outer loop result that includes updated thermodynamic and physical properties; and control the computational simulator to terminate performance of the inner loop and the outer loop responsive to iterative convergence of the outer loop result.

As an example, one or more computer-readable media may include computer-executable instructions executable by a system to instruct the system to: control a computational simulator to perform an inner loop that solves mass balance and energy balance of a rate-based separation process using thermodynamic and physical properties to generate an inner loop result; control the computational simulator to perform an outer loop using the inner loop result to generate an outer loop result that includes updated thermodynamic and physical properties; and control the computational simulator to terminate performance of the inner loop and the outer loop responsive to iterative convergence of the outer loop result.

As an example, a computer program product may include one or more computer-readable storage media that may include processor-executable instructions to instruct a computing system to perform one or more methods and/or one or more portions of a method.

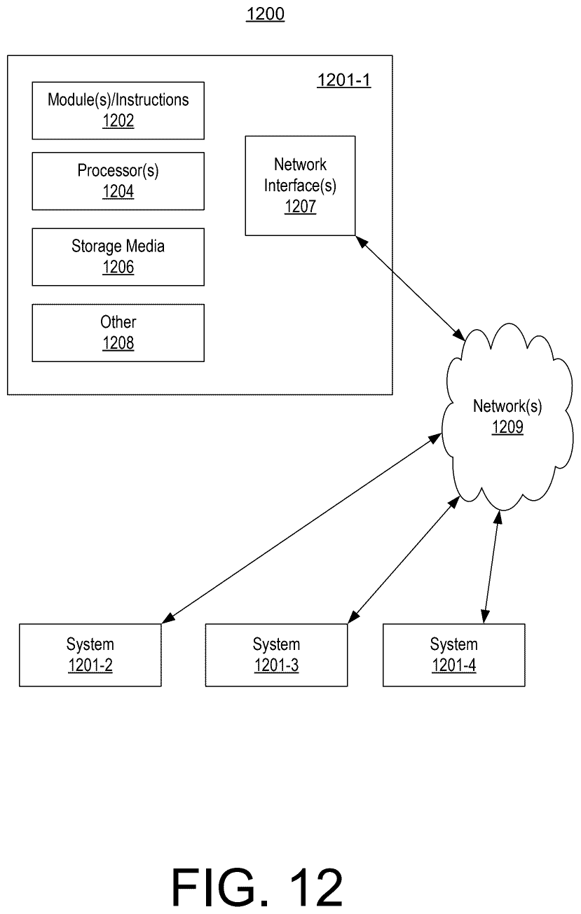

In some embodiments, a method or methods may be executed by a computing system. FIG. 12 shows an example of a system 1200 that may include one or more computing systems 1201-1, 1201-2, 1201-3 and 1201-4, which may be operatively coupled via one or more networks 1209, which may include wired and/or wireless networks. As shown, one or more other components 1208 may be included in the system 1200.

As an example, a system may include an individual computer system or an arrangement of distributed computer systems. In the example of FIG. 12, the computer system 1201-1 may include one or more modules 1202, which may be or include processor-executable instructions, for example, executable to perform various tasks (e.g., receiving information, requesting information, processing information, simulation, outputting information, etc.).

As an example, a module may be executed independently, or in coordination with, one or more processors 1204, which is (or are) operatively coupled to one or more storage media 1206 (e.g., via wire, wirelessly, etc.). As an example, one or more of the one or more processors 1204 may be operatively coupled to at least one of one or more network interface 1207. In such an example, the computer system 1201-1 may transmit and/or receive information, for example, via the one or more networks 1209 (e.g., consider one or more of the Internet, a private network, a cellular network, a satellite network, etc.).

As an example, the computer system 1201-1 may receive from and/or transmit information to one or more other devices, which may be or include, for example, one or more of the computer systems 1201-2, etc. A device may be located in a physical location that differs from that of the computer system 1201-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1206 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that may be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
controlling a computational simulator to perform an inner loop that solves mass balance and energy balance of a rate-based separation process using thermodynamic and physical properties to generate an inner loop result;
controlling the computational simulator to perform an outer loop using the inner loop result to generate an outer loop result that comprises updated thermodynamic and physical properties; and
controlling the computational simulator to terminate performance of the inner loop and the outer loop responsive to iterative convergence of the outer loop result.

2. The method of claim 1, comprising implementing a homotopy approach for performance of the inner loop and the outer loop.

3. The method of claim 2, wherein the homotopy approach operates without a compositional dependency on inner loop enthalpy.

4. The method of claim 1, wherein the inner loop utilizes an approximated thermodynamic matrix.

5. The method of claim 4, wherein the approximated thermodynamic matrix is implemented in the inner loop without generating thermodynamic derivatives.

6. The method of claim 1, comprising controlling the computational simulator to set an initial condition of negligible liquid mass transfer.

7. The method of claim 6, comprising operating the computational simulator such that a vapor interface composition is driven to match a vapor bulk composition and such that a liquid interface composition is defined through an equilibrium relationship with the vapor interface composition.

8. The method of claim 1, wherein the rate-based separation process comprises separation of CO2 from an inlet gas stream.

9. The method of claim 8, wherein the rate-based separation process comprises utilization of an absorber liquid stream to absorb CO2 from the inlet gas stream.

10. The method of claim 1, wherein the rate-based separation process comprises one or more of a tray-based process and a packed-based process.

11. The method of claim 1, wherein the iterative convergence of the outer loop is assessed using one or more convergence criteria.

12. The method of claim 1, comprising instructing a controller to control separation equipment based at least in part on the outer loop result.

13. The method of claim 12, comprising receiving sensor-based data from one or more sensors of the separation equipment and comparing one or more of the inner loop result and the outer loop result to at least a portion of the sensor-based data.

14. The method of claim 13, comprising controlling the computational simulator responsive to the comparing.

15. The method of claim 14, wherein the controlling of the computational simulator responsive to the comparing comprises switching one or more computational techniques of one or more of the inner loop and the outer loop.

16. The method of claim 1, comprising controlling the computational simulator to perform a simulation for the rate-based separation process using a different operational mode to iteratively converge to a benchmark result.

17. The method of claim 16, comprising comparing one or more of the inner loop result and the outer loop result to the benchmark result.

18. The method of claim 17, comprising, responsive to the comparing, selecting an operational mode from a number of different operational modes and controlling the computational simulator to operate according to the selected operational mode.

19. A system comprising:
a processor;
a memory accessible to the processor;
processor-executable instructions stored in the memory and executable by the processor to instruct the system to:
control a computational simulator to perform an inner loop that solves mass balance and energy balance of a rate-based separation process using thermodynamic and physical properties to generate an inner loop result;
control the computational simulator to perform an outer loop using the inner loop result to generate an outer loop result that comprises updated thermodynamic and physical properties; and
control the computational simulator to terminate performance of the inner loop and the outer loop responsive to iterative convergence of the outer loop result.

20. One or more computer-readable media comprising computer-executable instructions executable by a system to instruct the system to:
control a computational simulator to perform an inner loop that solves mass balance and energy balance of a rate-based separation process using thermodynamic and physical properties to generate an inner loop result;
control the computational simulator to perform an outer loop using the inner loop result to generate an outer loop result that comprises updated thermodynamic and physical properties; and
control the computational simulator to terminate performance of the inner loop and the outer loop responsive to iterative convergence of the outer loop result.
